(19) United States
(12) Patent Application Publication
(10) Pub. No.: US 2020/0328805 A1
(43) Pub. Date: Oct. 15, 2020

(54) MODERN INTERRUPTIBLE FOLDBACK SYSTEM AND METHODS

(71) Applicants: Sophie Erber, Marquette, MI (US); Nels Edward Benda, Hancock, MI (US); Zachary Robert Erkkila, Larium, MI (US)

(72) Inventors: Sophie Erber, Marquette, MI (US); Nels Edward Benda, Hancock, MI (US); Zachary Robert Erkkila, Larium, MI (US)

(21) Appl. No.: 16/847,598

(22) Filed: Apr. 13, 2020

Related U.S. Application Data
(60) Provisional application No. 62/832,806, filed on Apr. 11, 2019.

(51) Int. Cl. H04B 7/26

(52) U.S. Cl. CPC H04B 7/26; H04W 84/12

(57) ABSTRACT

Forms of a modern interruptible foldback system are disclosed. In one form, the system comprises an audio interface that converts output from a director's mic and one or more analog audio streams to digital data for digital processing and mixing by a director application on a director computing device. Output from the director application of the director computing device is one or more mixed streams of digital audio data for transfer via a data transfer network to one or more talent computing devices running a talent application. The mixed audio is then fed by wired or wireless transfer to an in-ear or external speaker for a specified talent. The system's director app and talent app provide discreet 2 way communication between director and talent during a live broadcast. In alternative embodiments, analog audio streams are premixed before conversion to digital and distributed.

### CROSS REFERENCE TO RELATED APPLICATIONS

This application claims priority to Provisional Patent Application No. 62/832,806 filed Apr. 11, 2019, the entire disclosure of which is hereby incorporated by reference and relied upon.

### BACKGROUND OF THE INVENTION

Field of the Invention. The invention relates generally to communication devices used in television and radio and more particularly to interruptible foldback systems for communicating between directors and on-air talent and other technical staff.

Description of Related Art. The interruptible foldback (IFB) is a system commonly used in television, radio, and other areas to communicate for example from a director to on-air talent. The system provides a method for the director to cue and direct the talent without making it known to the audience. Current systems are expensive, bulky, and rely on old technology. In use, these systems utilize a plethora of wires that run underneath and around clothing to unsightly receiver boxes strapped typically to the leg of the talent. The systems are annoying to the talent particularly in situations where the talent must move around and interact with others in the broadcast. In addition, the wires associated with these systems can be a hazard. Other issues with current IFB systems include: poor audio quality, frequent dropouts, the inability for the talent to have control over the IFB device, and the inability for the talent to signal the director.

What is needed is a modern IFB system that is affordable, lightweight, completely wire free, with enhanced audio quality and improved reliability. In addition, what is needed is a modern IFB system that provides the option to discretely communicate with a director while on the air.

### SUMMARY OF THE INVENTION

In one form, a modern interruptible foldback (IFB) system comprises a talent software application processed on a talent computing device.

In one form, a modern interruptible foldback system comprises a director software application processed on a director computing device.

In one form, the talent software application (also known as client application) and the director software application is compatible with Mac, Windows, iOS, and android operating systems.

In one form, the talent software application is a client application.

The word ‘talent’ in this disclosure refers not only to ‘on air’ and ‘on screen’ talent but also to technical staff such as camera operators, and others that the director wishes to have communication with through the modern interruptible foldback system.

In one form, the talent and director computing devices are one or more of: a smart phone, tablet, personal digital assistant (PDA), server, desktop computer, laptop computer, programmable module (i.e. raspberry pi), and programmable custom electronic device, including at least a microprocessor.

In one form, a modern interruptible foldback system integrates with common off the shelf electrical components.

In one form, the director software application executed on a processor of the director computer effectuates the director's computer to display talent that is connected to the modern IFB system, to talk through the system to individual or multiple users of the modern IFB system, and adjust volumes of the feeds and volumes for the talent.

In one form, the talent software application is a client application.

In one form, the talent software application executed on a processor of one or more of the talent computers effectuates the talent computer to: interact with the director app, optionally override the volume of the talent's listening device, and signal the director.

In one form, a USB audio interface is utilized as a common off the shelf component of a modern interruptible foldback system.

In one form, a multi-channel audio input device such as a Focusrite Scarlett 2i2 is utilized as one common off the shelf component of a modern IFB system.

In one form, a data transfer network is utilized for transfer of data between a director computing device and one or more talent computing devices.

In one form, the data transfer network is in the form of one of: WiFi, wired Ethernet, direct (Peer to Peer), and GSM.

In one form, a director display coupled to the director computing device displays a list of all talent and other individuals electrically coupled to the modern IFB.

In one form, a periodic status message is received on the director display adjacent a display of talent and other individuals electrically coupled to the modern IFB whereby the periodic status message signifies to the director that the corresponding talent computing device is connected/disconnected to the modern IFB system.

In one form, a director exerts control (director input) in a director feed control module over the modern interruptible foldback system by responding to graphic user interface options on the director display associated with instructions executed in the director software application and processed on the director computer. The director input in the director feed control module is used to control features such as but not limited to: the master volume, and the volume to each user.

In one form, the director input is used to control talk to specific users of the system.

In one form, audio data is transmitted over WiFi to connected clients running the talent application and played through a Bluetooth earpiece paired with their talent computing device.

In one form, software utilized with the modern interruptible foldback system is programmed to utilize computing resources from one or more clients (talent computing devices).

In one form, mixing values are packeted alongside audio data and sent to client (talent) applications where the audio is mixed according to specified values thereby making the modern interruptible foldback system scalable and override a specified mix which is not possible with pre-mixed audio.

In one form, the talent software application running on a processor of a talent computer effectuates on the talent display (i.e. via a display card), a signal button that when activated for example by talent input such as touching (on a touch screen monitor), or by clicking or sliding a signal button icon (i.e. using a mouse), causes a consequent signal to be sent to the director computer to notify the director that the talent desires to communicate with the director.

In one form, data is streamed to remote cell phone users having a data connection over WiFi.

In one form, mixing setting and individual channel audio data from audio streams are sent in a combined packet to each individual talent computing device.

In one form, mixing of audio streams is completed in the director computing device.

In one form, audio streams and mixing commands are separated for further expandability whereby each client application has access to the streams coming from the server (director computing device) but mixed based on a separate individualized or grouped command stream. Such an arrangement reduces the load on the server, allows for tighter synchronization between clients in large scale applications and reduces network bandwidth.

In one form, the modern interruptible foldback system comprises messaging whereby pre-programmed messages can be exchanged between a director computer and one or more talent computers. As just one example, the talent may activate a ‘water’ icon on a talent display thereby signaling to the director that water is needed by the talent at commercial break.

In one form, a director application operates on an audio routing computing device which may be at a location separated from the director.

In one form, one or more analog audio streams for each talent are one or more of: amplified, mixed, then converted from analog to digital at an audio interface which acts as an audio to digital converter.

In one form, audio streams for each talent include one or more live and pre-recorded audio streams.

In one form, audio streams for each talent include a director stream comprising audio from a director microphone.

In one form, one or more audio streams is amplified before being sent to an audio mixer.

In one form, an audio mixer in the modern IFB mixes audio for an individual talent.

In one form, the modern IFB system comprises a plurality of audio mixers each outputting mixed audio for an individual talent.

In one form, the modern IFB system utilizes an individual mic for the director to address each talent independently.

In one form, each director mic comprises an activation control that is operated manually or by software switch to activate and inactive a selected director microphone for a designated talent.

In one form, one form a TASCAM US-16X08 is utilized as an audio interface for analog to digital conversion of each talent mixed audio.

In one form, mixed audio streams intended for each talent are routed to a designated talent by a director app operating on a audio routing computing device.

In one form of a modern interruptible foldback system, any number of audio streams are mixed in one or more analog audio mixers before being converted to a digital stream at an audio interface and fed to an audio routing computing device before each individual stream is transferred to the respective talent computing device.

In one form, audio streams are mixed at the talent computing device.

In one form, audio streams are mixed at the director computing device.

In one form, utilization of a modern interruptible foldback system comprises the following steps. A director activates a director software application on a director computing device. An audio device is plugged in to a USB port and is set as the default audio input device for the director computer. In one embodiment, a Focusrite Scarlett 2i2 is utilized however, the director software can be extended to other devices. The Scarlett 2i2 has two audio input lines that correspond with “Feed 1” and “Feed 2” respectively in director software application. A microphone is electrically coupled with Line 1 and utilized as a director feed of the audio input device (i.e. Scarlett 2i2). The broadcast feed in the form of audio line and broadcast audio is electrically coupled with Line 2. The talent software application is activated. The talent activates a control for setting their name signaling to the director screen the talent's identity. Simultaneously, the talent app connects to the IP address and port on which the director app is running causing consequent streaming of the audio to the talent.

### BRIEF DESCRIPTION OF THE SEVERAL VIEWS OF THE DRAWINGS

These and other features and advantages of the present invention will become more readily appreciated when considered in connection with the following detailed description and appended drawings, wherein each drawing is according to one or more embodiments shown and described herein, and wherein:

FIG. 1 depicts a flow chart view of a modern IFB illustrating a director operating a director app and one or more talent operating a talent app;

FIG. 1B depicts a flow chart view of a modern IFB whereas analog audio streams intended for each talent are mixed before digitizing and routed to each talent;

FIG. 2 depicts a schematic view of various computing components of computing systems that may be used in a modern IFB system;

FIG. 3 depicts a flow chart view of one method of operation of a modern interruptible foldback operation;

FIG. 3A depicts a flow chart view of one method of operation of a modern interruptible foldback operation consistent with the system depicted in FIG. 1B;

FIG. 4 depicts a flow chart view of one method of studio communication operation of a modern interruptible foldback;

FIG. 5 depicts a flow chart view of an operational process of a modern interruptible foldback;

FIG. 6 depicts a flow chart view of a method of human and machine actions when a talent utilizes a user interface of a talent computing device running the talent application to send a message to a director;

FIG. 7 depicts a screen view of graphical information displayed on a director display that is electrically coupled with a director computing device;

FIG. 8 depicts a screen view of graphical information displayed on a director display that is electrically coupled with a director computing device whereas the graphical information includes controls for using an audio input device;

FIG. 9 depicts a screen view of graphical information displayed on a director display that is electrically coupled with a director computing device as might be used in the FIG. 1B system.

FIG. 10 depicts a screen view of graphical information displayed on a director display that is electrically coupled with a director computing device as might be used in the FIG. 1B system.

FIG. 11 depicts a screen view of the graphical information on a talent display electrically coupled with a talent computing device;

FIG. 12 depicts a screen view of the graphical information on a talent display electrically coupled with a talent computing device.

FIG. 13 depicts an example of a software algorithm utilized by an application in a modern interruptible foldback system;

FIG. 14 depicts an example of a software algorithm utilized by an application in a modern interruptible foldback system.

### DETAILED DESCRIPTION OF SELECTED EMBODIMENTS OF THE INVENTION

Select embodiments of the invention will now be described with reference to the Figures. Like numerals indicate like or corresponding elements throughout the several views and whereas various embodiments are separated by letters (i.e. 100A, 100B, 100C). Numbered elements absent of letters (i.e. 100, 101, 102) indicate elements that may be generally used in a variety of embodiments. The terminology used in the description presented herein is not intended to be interpreted in any limited or restrictive way, simply because it is being utilized in conjunction with detailed description of certain specific embodiments of the invention. Furthermore, embodiments of the invention may include several novel features, no single one of which is solely responsible for its desirable attributes or which is essential to practicing the invention described herein.

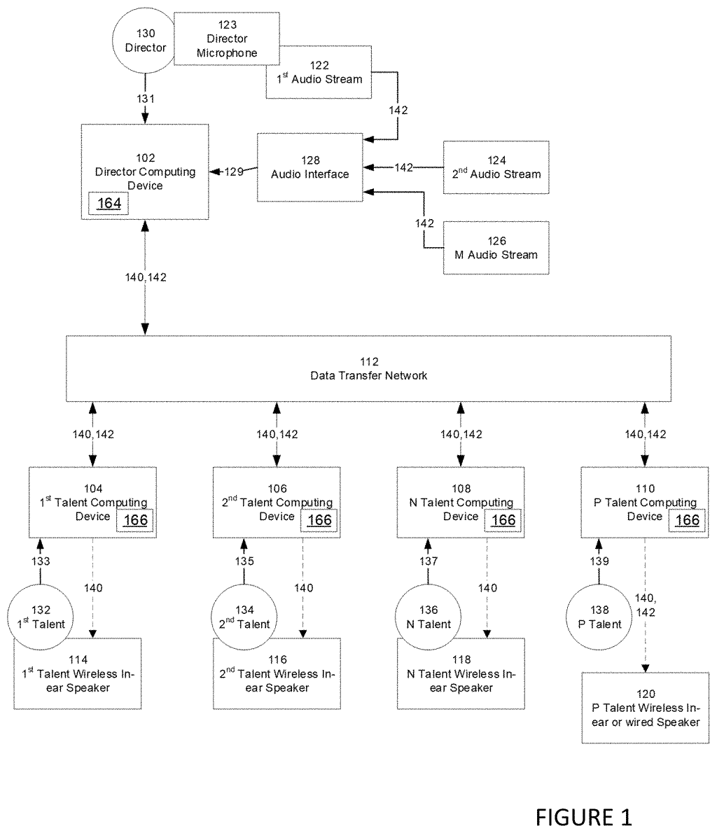

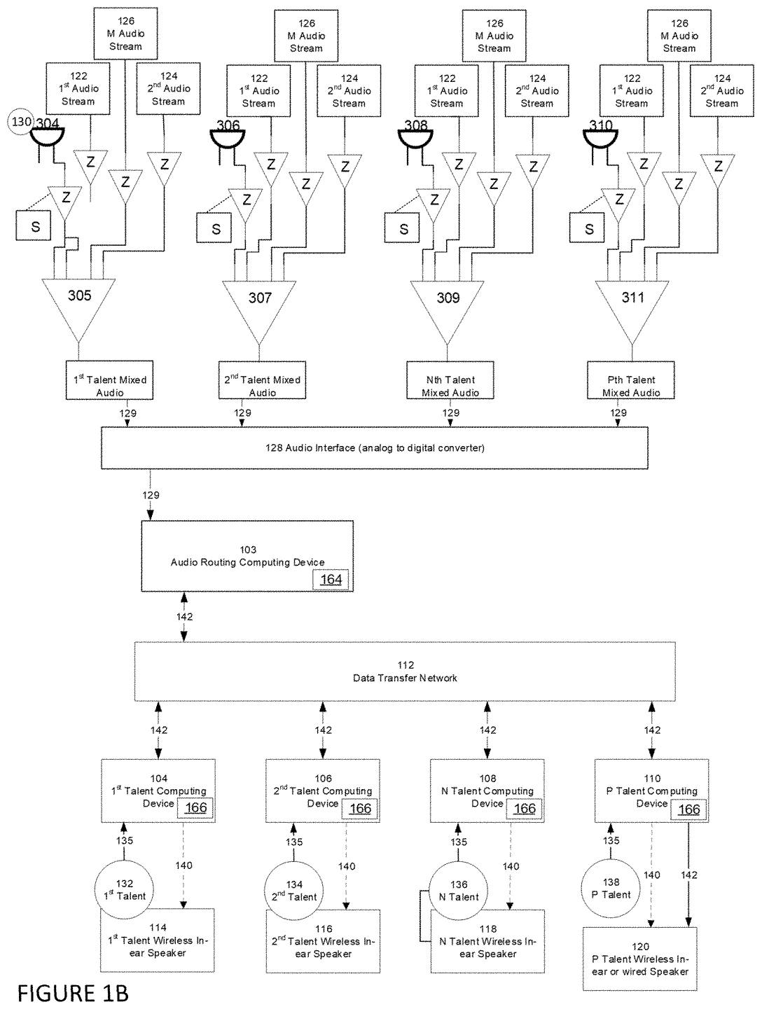

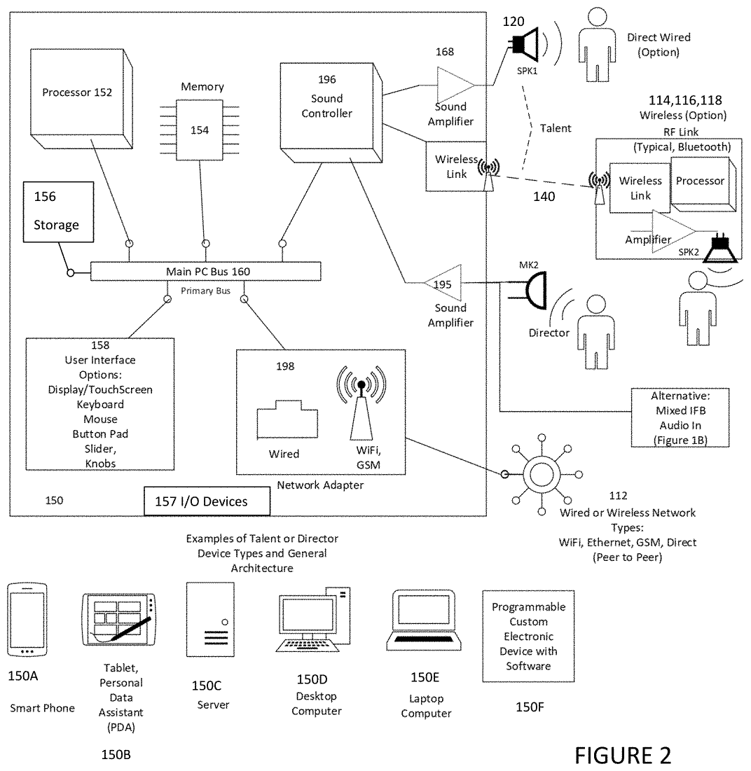

FIG. 1 illustrates one embodiment of system architecture for a modern interruptible foldback system representing a configuration that may be utilized for example in a television newsroom. Distanced from broadcast cameras or broadcast microphones, a director 130 provides director input 131 using a user interface 158 on director computing device 102. The director computing device 102 comprises a processor 152 (FIG. 2) for execution of instructions given by director application 164 software. A first audio stream 122 (typically at least the director's primary microphone 123), and optionally a second audio stream 124, and M audio stream 126 representing any number of additional yet optional audio streams input into audio interface 128 preferably by wired connection 142 such as audio cable. In this embodiment, audio interface 128 digitizes the audio signals and outputs the digitized audio signals as interface audio input 129 typically by USB connection to director computing device 102. In alternative embodiments, one or more of the audio streams are input directly to input/output circuits on the computer thereby bypassing the need for an external audio interface.

Further to FIG. 1, a first talent 132 (i.e. newscaster, camera operator), optionally a second talent 134, and any one or more talents represented by example as talent N and P are assigned their own respective computing devices with each computing device executing instructions from talent application 166 (client) software on respective first talent computing device 104, second talent computing device 106, N talent computing device 108, and P talent computing device 110. Each talent computing device receives input from each respective talent (i.e. first talent input 133, second talent input 135, N talent input 137, and P talent input 139) through user interface 158 (FIG. 2) such as a computer display. A wireless signal from each talent computing device 104/106/108 extends to a respective first talent wireless in-ear speaker 114, second talent wireless in-ear speaker 116, and N talent wireless in-ear speaker 118. As illustrated in FIG. 1, the wireless in-ear speaker (note wireless connection 140) may be substituted for example by a wired speaker if so desired as noted with wired speaker 120 using wired connection 142 extending from P talent computing device 110.

In this embodiment (FIG. 1), the director computing device 102 and each talent computing device (i.e. one or more of: first talent computing device 104, second talent computing device 106, N talent computing device 108, and P talent computing device 110) are electrically connected by wired connection 142 such as ethernet to a data transfer network 112 for transference of data such as audio signals and messaging between the director and talent computing devices. Alternatively, this connection may be wireless 140 utilizing a standard such as WiFi or GSM.

The talent software application 166 effectuates on the associated talent display 200, a signal button 235 (FIG. 12) that when activated by user interface 158 (for example by touching on a touch screen monitor, or by clicking or sliding a signal button icon) consequently causes a signal to be sent to the director computer to notify the director by illumination of an on screen indicator such as illuminated call light 236B that the talent wishes to communicate with them. Note for example, call light 236B illuminated in FIG. 8 in response to ‘Sophie’ activating her signal button 235.

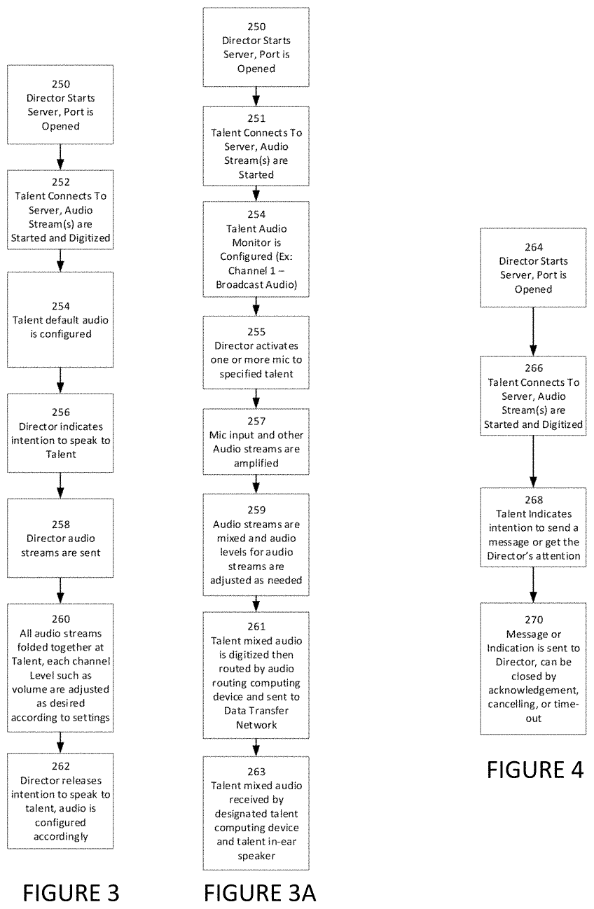

FIG. 3 is a flowchart illustrating the steps of operation of one embodiment of a modern interruptible foldback as disclosed herein and consistent with FIG. 1. The process begins at 250 with the director starting their director computing device 102 thereby opening a port. At step 252, each talent also starts their respective computing devices (i.e. 104, 106, 108, 110 etc.) and also start first audio stream 122, and optional second audio stream 124, through M audio stream 126. The audio streams are digitized in audio interface 128. In alternative embodiments, one or more audio streams may be input directly into the director computing device to one or more input-output circuits 157 such as the sound amplifier 168 illustrated in FIG. 2.

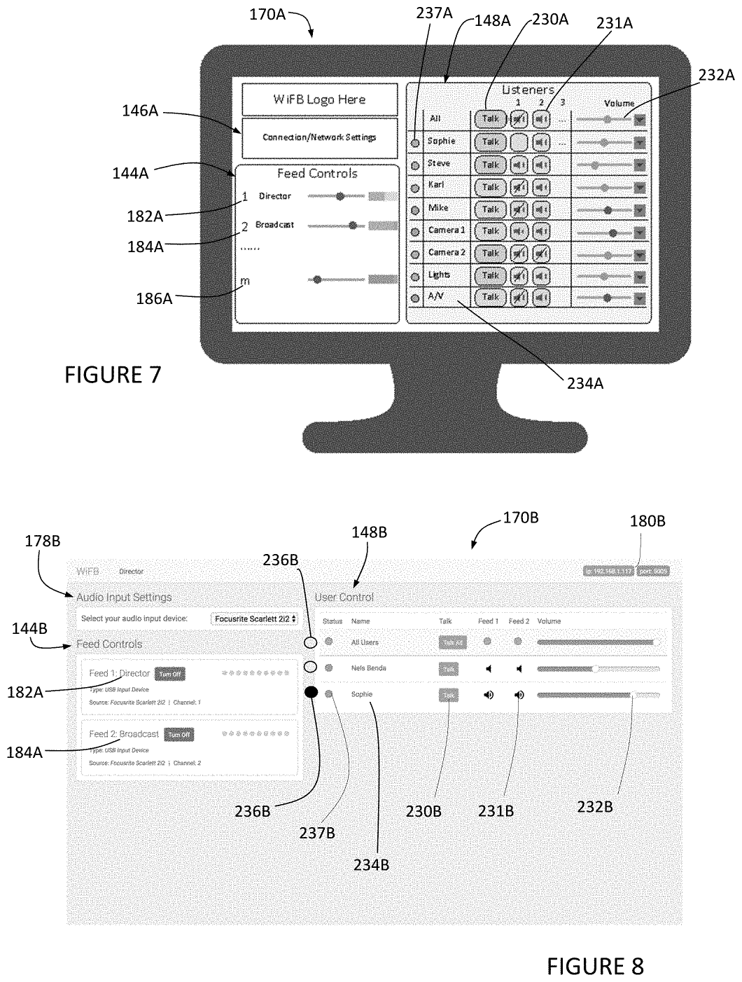

At step 254, the talent audio is configured. For example, user control module 148A (FIG. 7) on director display 170A illustrates a multitude of configurations that may be available.

At step 256, the director indicates an intention to speak to a specified talent by utilizing director input 131 from director 130 on user interface 158 which may for example be in the form of touching a display (i.e. touchscreen) or using a computer mouse to click an icon or adjusting a slider on a display associated with director computing device 102 (i.e. talk control button 230A). In some embodiments an activation control (i.e. a button) is used to indicate an intention to speak. As a result of this action, verbal dialog from director primary microphone 123 is transmitted to one or more specified talent computing devices (i.e. 104, 106, 108, 110) over data transfer network 112. Each talent computing device then wired or wirelessly transmits the verbal dialog captured by director primary microphone 123 to a respective talent wireless in-ear or wired speaker (i.e. 114, 116, 118, 120). Simultaneously, as illustrated at step 258, additional audio streams controlled by the director (i.e. second audio stream, M audio stream) may also be sent to designated talent. As illustrated at step 260, the second audio stream 124 and other remaining audio streams are folded (mixed) into channel 1 and played through the in-ear speaker or wired speaker of the designated talent. In this embodiment, talent speaker volume levels may be adjusted at the director display 170 of director computing device 102 or overridden with user interface adjustment at a talent display 200 of a respective talent computing device (i.e. 104, 106, 108, 110). When the director 130 completes their communication, communications from director primary mic 123 is ceased by appropriate user interface command by the director as illustrated at step 262 (i.e. shutting off mic).

FIG. 4 illustrates similar steps of operation for talent (i.e. 132, 134, 136, 138, as required per studio) to transmit communication to a director 130. The process begins at step 264 with the director starting their director computing device 102 thereby opening a port. At step 266, each talent also starts their respective computing devices (i.e. 104, 106, 108, and 110) and also starts first audio stream 122, and optional second audio stream 124 through M audio stream 126. The audio streams are digitized through audio interface 128. At step 268, the talent (i.e. first talent 132, second talent 134, N talent 136, P talent 138) indicates an intention to speak to the director 130 by utilizing talent input (i.e. first talent input 133, second talent input 135, N talent input, P talent input) by user interface 158 which may for example be in the form of touching a display (i.e. touchscreen) or using a computer mouse in communication with the computer to click an icon or adjust a slider on a display associated with a respective talent computing device (i.e. 104, 106, 108, 110) such as signal button 235. This action causes consequent action of sending a predefined communication (step 270) to the director 130 over data transfer network 112. In preferred embodiments, the communication sent to the director is in the form of a message displaying on the director display 170 associated with the director computer device 102 or may simply be an indicator such as a red dot illuminated (i.e. call light 236) on the director display 170 indicating the one or more of the talent (i.e. 132, 134, 136, 138) needs attention. Confirmation that the communication was received may be by way of an acknowledgement communication sent from the director computing device, by the director cancelling the request by use of director input 131, or the communication being automatically removed from the director's display after a preset time period.

FIG. 5 illustrates a preferred embodiment of operational process of a modern interruptible foldback. The process begins with the director computing device 102 establishing communication with a network port of data transfer network 112 preferably using a UDP protocol (step 272). One or more talent computing devices (i.e. first talent computing device 104, second talent computing device 106, n talent computing device 108, p talent computing device) establish communication with a network port of data transfer network 112 as illustrated at step 274. Each talent computer transmits a periodic message over data transfer network 112 for display on director display 170 associated with the director computing device 102 indicating to the director 130 that the corresponding computer is connected (step 276). The director then configures parameters in the user control module 148 using the user interface (step 278). Using an internal sound controller 196 or external audio interface 128 to digitize the audio streams, one or more audio streams (i.e first audio stream 122, second audio stream 124, M audio stream 126) are fed into audio interface 128 or other sound controller (step 280) and into the director computing device 102 for processing. The director computer device processor 152 recognizes the predefined configuration of each talent computing device (i.e. 104, 106, 108, 110) and sends one or more data packets of the audio and with unique configuration to each talent computing device via data transfer network 112 (step 282). Each talent computing device receives the data intended for them (step 284) via data transfer network 112. In this example, the data may include for example configuration data (i.e. volume level) related to the audio channel heard by the respective talent. As illustrated in step 286, data received by the respective talent computer is then processed and used to control the output of the wireless or wired speaker of the respective talent. Optionally, the talent can override the configuration data received from the director computing device. This override is completed by user interface talent input which may for example be in the form of touching a display (i.e. touchscreen) or using a computer mouse to click an icon or adjust a slider on a talent display associated with a respective talent computing device 104, 106, 108, 110 (step 288) and whereby the override configurations from the talent are utilized (step 290). FIG. 10 illustrates one example of a talent override whereby a talent volume control 206 is available for talent to override volume.

The mixed audio is then routed from the talent computing device (i.e. first talent computing device 104) to the respective to sound controller 196 (step 294). Here the mixed audio takes one of two paths. In a first path, the talent computing device converts the digitized audio signal and amplifies it (i.e. sound amplifier 168) for output to a speaker 120 (step 296). In an alternative path, a wireless connection 140 is opened to a wireless earphone (i.e. 114,116,118, 120) (step 298) whereby the respective talent computer sends the digitized audio to the wireless earphone via the wireless link (step 300). Circuitry within the wireless earphone converts the digitized signal to analog and amplifies to a desired level (step 302).

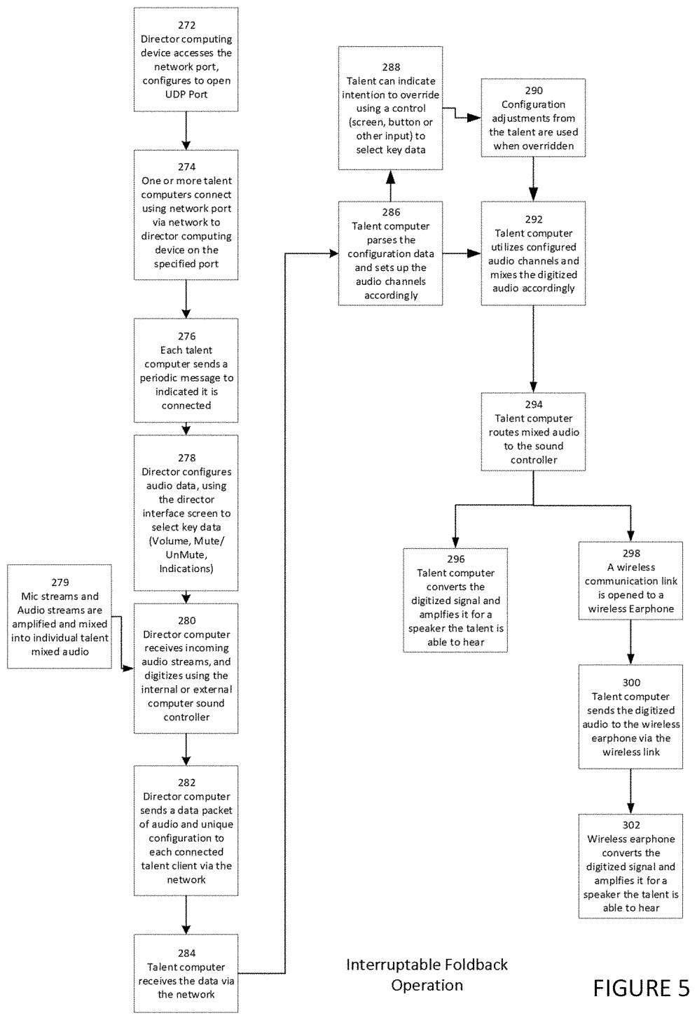

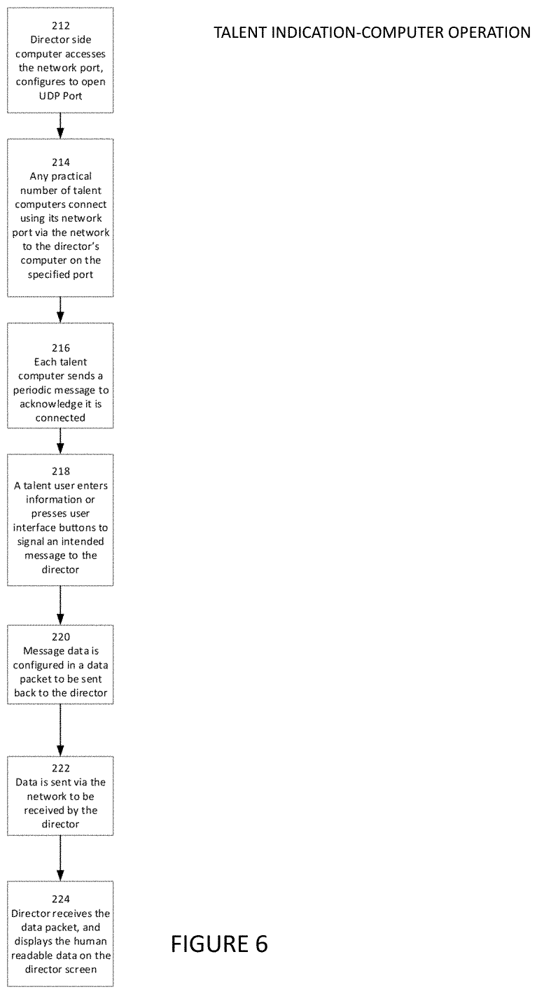

FIG. 6 illustrates step by step one embodiment of human and machine actions when talent utilizes a user interface 158 to send a message to a director. A director computing device 102 is started and accesses a port on data transfer network 112 (step 212). One or more talent computing devices (i.e. 104, 106, 108, 110 as needed) are started and electronically connect through a specified port of data transfer network 112 to director computing device 102 (step 214). At this point, each talent computing device responding to instructions processed from the talent application 166 sends a periodic signal across the data transfer network 112 that is processed in the director computing device 102 and displayed on the associated director display 170 to acknowledge that the specific computing device is connected (step 216). Talent at their respective talent computing device utilizes their user interface 158 (i.e. signal button 235) to signal an intended message to the director (step 218). Message data processed by the respective talent computing device is configured in a data packet (step 220) and sent through data transfer network 112 (step 222) to director computing device 102 where the data in the data packet is processed and displays the message data on the screen of the director computing device (step 224).

FIG. 7 illustrates one embodiment of graphical information displayed on a director display 170A electrically coupled with a director computing device 102. Instructions from director application 164 stored on a storage device 156 of the director computing device 102 run on processor 152. Input/output circuits release control signals such as audio, and video signals to produce the interactive display illustrated in FIG. 7 on director display 170A. Here, in a director feed control module 144A, interactive controls of the various audio streams are displayed. For example, controls for the director stream 1 volume 182A, the broadcast stream 184A, M stream 186A are accessible as illustrated. In a director input/network control module 146A, interactive controls related to network settings and connection ports are accessible and may also include controls for choosing an audio input device (FIG. 8). In a user control module 148A, displayed are one or more interactive controls which may include: talent line switches 231A to turn on/off audio feeds to various users, talk control 230A to selectively allow access to voice signals from the director to a specific user, stream control 231A to selectively determine which audio streams are heard by each talent side user, and volume control 232A to selectively adjust the volume of the audio stream sent to each user. A user title box 234A helps identify each user on director display 170A in the user control module 148A. FIG. 8 illustrates an alternative director display 170B having similar interactive controls. Director display 170B also illustrates call indicators (call light 236B) associated with each talent for indication to the director the corresponding talent needs their attention. In addition, one or more of director displays and talent displays may comprise a connection indicator 237B giving an on screen display of connection status of each individual talent IFB indicating whether each IFB ready for use. IP address/port display 180 displays the current IP address and port used by a particular component of the system.

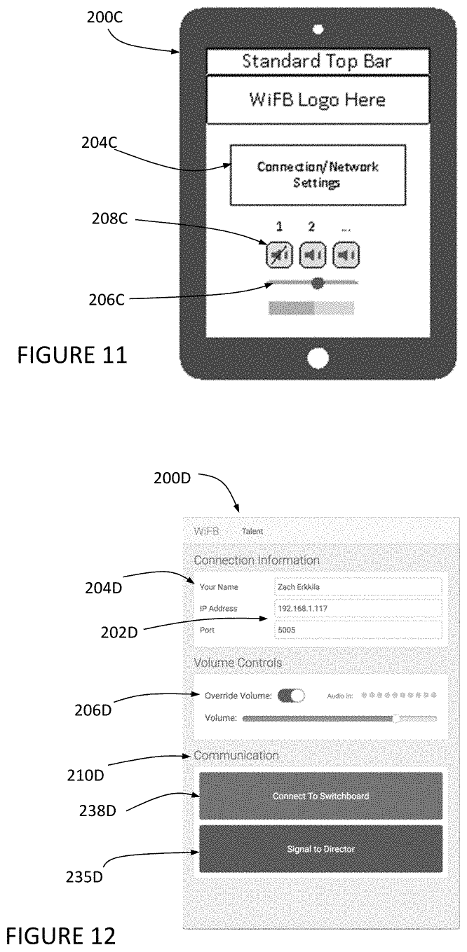

FIG. 11 illustrates one embodiment of the graphical information on a talent display 200C electrically coupled with a talent computing device. Instructions from talent application 166 stored on a storage device 156 or memory 154 of a talent computing device (i.e. first talent computing device 104, second talent computing device 106, N talent computing device 108, P talent computing device 110) run on processor 152 and direct input/output circuits to release control signals such as audio and video signals to produce the interactive display illustrated in FIG. 11 or alternatively FIG. 12 on the corresponding talent display 200D. In the embodiment of FIG. 11, talent display 200C comprises a talent network control module 204C having interactive controls related to network settings and connection ports. Additionally, on the screen are one or more talent feed toggles 208C to selectively turn on or mute various audio streams from other users. A talent volume control 206C provides interactive volume adjustment over the respective wireless in-ear speaker or wired speaker. This serves as an optional override of a director's preset volume values. In a talent network control module 204D as illustrated in FIG. 12, the user controls connection parameters such as IP address and port which is displayed as talent/port address display 202D. Further in the embodiment of FIG. 12, talent display 200D comprises one or more quick toggles 210D. For example, in one form a quick toggle is in the form of a quick message toggle (i.e. signal button 235D) which sends a signal to the director for display on the director display (i.e. call light 236B) to indicate that the user requires the director's attention. In alternative embodiments, a quick message toggle may indicate that the talent is “low on power”. Another form of a quick toggle is a quick connect toggle 238D, which provides a single toggle for the talent to quickly connect their talent computing device to data transfer network 112.

FIG. 1B illustrates an example configuration of a modern interruptible foldback system according to yet another embodiment of this disclosure. In this embodiment, note that any number of audio streams are mixed in an analog audio mixer before being converted to a digital stream at an audio interface and fed to an audio routing computing device before each individual stream is transferred to the respective talent computing device. In a basic form, the system includes at least a first audio stream 122 and audio from a first mic 304 (capturing instructions from a director) that are amplified by one or more sound amplifiers ‘Z’ and then mixed in a first audio mixer 305 to create first talent mixed audio. This first talent mixed audio is then provided to audio interface 128 for analog to digital conversion. However, as illustrated, the number of audio streams processed by the system may also be any number more than 1 and the number of director mic inputs may also be any number greater than 1. This is illustrated in FIG. 1B for example as first mic 304, first audio stream 122, second audio stream 124, and M audio stream 126 that are mixed to create first talent mixed audio. In most cases however, there is more than one talent that a director will desire to communicate with during a live broadcast. Therefore, the system is again equipped to process any variety of audio streams intended for a varying number of talent involved in the production. This is illustrated by the second talent mixed audio, Nth talent mixed audio, and Pth talent mixed audio in the Figure. For example, the 2^{nd} talent mixed audio may comprise a combination of first audio stream 122, second audio stream 124, M audio stream 126, and director verbal input from second mic 306. Similarly, the N talent mixed audio may comprise a combination of first audio stream 122, second audio stream 124, M audio stream 126, and director verbal input from third mic 308. The Nth talent mixed audio may comprise a combination of first audio stream 122, second audio stream 124, M audio stream 126, and director verbal input from third mic 308. The Pth talent mixed audio comprises a combination of first audio stream 122, second audio stream 124, M audio stream 126, and director verbal input from second mic 310.

There are of course several variations of this system one skilled in the art would recognize while still being within the scope of this disclosure. For example, the audio streamed to each talent in the illustration is depicted as being identical, whereas each talent may receive one or a combination of audio streams that is different than that received by another talent. The first talent for example, may receive mixed audio formed from first audio stream 122 and second audio stream 124 while the second talent may receive mixed audio from first audio stream 122 and M audio stream 126. Similarly, in the depiction of FIG. 1, a separate microphone is assigned to mixed audio intended to be fed to each separate talent. Alternatively, a single microphone may be utilized that is switchable by software or physical switch for streaming to one selected or more talent. In this alternative, the director's 130 verbal instruction at any given time can be directed to a single designated talent, a combination of 2 or more talent, or all talent in the case where the director's wants all the talent to hear the same instructions at the same time.

As further noted in FIG. 1B, each audio stream is preferably amplified by sound amplifier ‘Z’ before being received by a respective audio mixer (i.e. first audio mixer 305, second audio mixer 307, third audio mixer 309, and fourth audio mix 311). In this case, a separate auto mixer is illustrated for each individual talent mixed audio. As would be recognized by those skilled in the art, each of these audio mixers can be physically separate units or can be combined into one or a reduced number of physical mixing units.

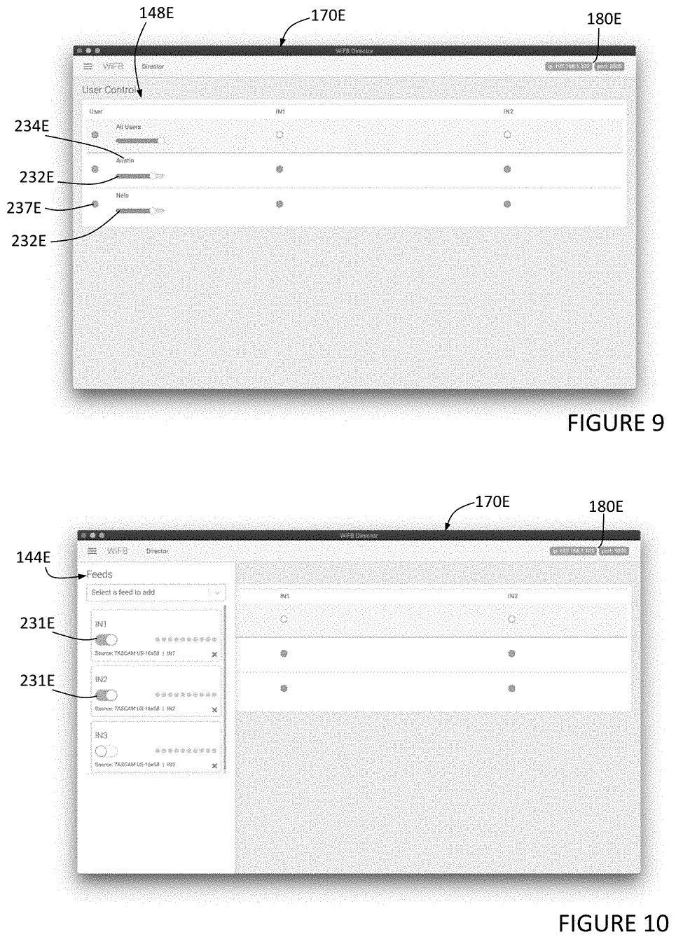

Given a modern interruptible foldback system as illustrated in FIGS. 1B, FIG. 9 depicts an example of the user facing options shown on the director display 170E of the director computing device 102E when using one embodiment of the modern interruptible foldback system 100E. In this embodiment, the graphical interface displays a connection indicator 180E to show details about connected devices and the connection to a network. In a user control module 148E, one or more user title boxes 234E are displayed to indicated talent connected to the system. For each connected talent, an onscreen volume control 232E is available for adjustment by the director using one of the user interface 158 options disclosed earlier. FIG. 10 also depicts an example of the user facing options shown on the director display 170E of the director computing device 102E displaying a director feed control module 144E consistent with FIG. 1B. The director feed control module 144E offers on screen control by use of the user interface 158 options to control the various audio feeds into the system. Stream control 231E are switches to activate/inactivate a particular audio feed such as IN1 and IN2. Note that in this embodiment, controls for 2-way communication between talent and director are absent.

FIG. 3A is a flowchart illustrating the steps of operation of one embodiment of a modern interruptible foldback as disclosed herein and consistent with FIG. 1B. The process begins at step 250 with the Director starting their director computing device 102 thereby opening a port. At step 251, each talent also starts their respective computing devices (i.e. 104, 106, 108, 110 etc.) and first audio stream 122, and optional second audio stream 124, through M audio stream 126. At step 254, the talent audio and streams are configured utilizing the screen options of FIGS. 9 and 10. At step 255, the director activates one or more mic (i.e. first mic 304, second mic 306, third mic 308, fourth mic 310) to provide individual instructions to one or more talent (FIG. 1B). The mic inputs from each mic and each audio stream utilized (i.e. first audio stream 122, second audio stream 124, M audio stream 126) are amplified by sound amplifiers ‘Z’ (step 257). The mics are activated by the manual or software driven activation controls ‘S’. At step 259, the audio streams and streams from the mics are mixed and audio levels for audio streams are adjusted as needed by the director in the respective mixing device (i.e. first audio mixer 305, second audio mixer 307, third audio mixer 309, and fourth audio mixer 311). At step 261, the talent mixed audio is then digitized at audio interface 128 before input into audio routing computing device 103 that is running director application 164 (the audio routing computing device 103 may alternatively be considered the director computing device 102). The digitized audio in the audio routing computing device 103 is then transferred to data transfer network 112 where is it directed to each talent computing device utilizing the process described earlier. The talent mixed audio specific to each talent is received in each talent computing device then carried by wired or wireless transmission to the talent's in-ear speaker or in some cases and external speaker (step 263). The talent speaker volume levels may be adjusted at the director display 170E of audio routing computing device 103 or overridden with user interface adjustment at a talent display 200 of a respective talent computing device (i.e. 104, 106, 108, 110). When the director 130 completes their communication, communications from director primary mic 123 is ceased by activation control ‘S ’. Noted further is that a director computing device 102 is readily accessible to a director while directing a live performance, whereas an audio routing computing device 103, although having similar computing specifications, may reside in an audio routing rack of the studio. In this case, the audio routing computing device 103 is accessible to the director but not easily during a live performance whereas the director computing device is available to the director and helpful with two-way communication with the talent.

As noted previously, FIG. 4 illustrates steps of operation for talent to transmit communication to a director 130. However, in the embodiment of FIG. 1B, this feature is not present.

As previously noted, FIG. 5 illustrates a preferred embodiment of an operational process of a modern interruptible foldback. This process remains substantially the same in light of the embodiment illustrated in FIG. 1B, however step 279 has been added to depict that the audio streams (i.e. 122, 124, 126) and audio streams from each mic (i.e. 304, 306, 308, 310) are mixed as analog signals then digitized in audio interface 128 before input into audio routing computing device 103 (known alternatively as director computing device 102). Alternatively, these analog audio streams can by-pass the audio interface and be digitized in an audio sound controller of the director computing device 102. The remaining steps of the process illustrated in FIG. 5 remain as previously described.

With respect to the system of FIG. 1B, FIG. 6 depicts a step by step process that provides individual talent the capability to send a message to the director from their talent computing device. This feature is not included in the FIG. 1B configuration and thus FIG. 6 does not apply.

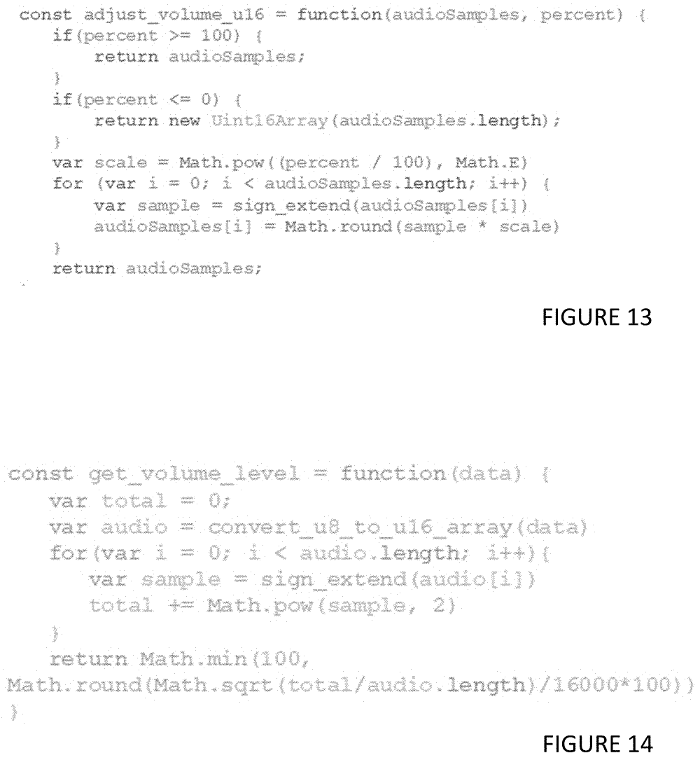

FIG. 13 and FIG. 14 depict examples of algorithms that may be used in the director application 164 and talent application 166 of a modern interruptible foldback system as disclosed herein. For example, the algorithm in FIG. 13 provides volume adjustment by scaling the samples exponentially to a percentage. Decibels are an exponential scale. FIG. 14 reflects an algorithm utilized to obtain volume using the root mean square and output as a percentage. For example, using one preselected audio protocol, audio data is piped from an audio interface 128 of the director application 164 of the director computing device 102 and separated into individual channels using SOX or another audio program available in the art. The audio data is then packeted as described below and sent to the talent applications 166 of talent computing devices (i.e. 104, 106, 108, 110) over UDP (user datagram protocol) with the following data packeting protocol. The protocol may be adjusted as recognized by those skilled in the art for use with other audio protocols.

$$\begin{matrix}Byte 0 \text{:} Number of feeds 0 \text{-} 255 \\ Byte 1 \text{:} Feed 1 \text{-} Master Volumn \\ Byte 2 \text{:} Feed 1 \text{-} Muted \\ Byte 3 \text{:} Feed 1 \text{-} Volumn \\ Byte 4 \text{:} Feed 1 \text{-} Audio Length Byte 1 \\ Byte 5 \text{:} Feed 1 \text{-} Audio Length Byte 2 \\ Byte 6 \text{-} Byte ( Audio Length From 4 and 5 ) \text{:} Feed 1 \text{-} Audio Data \\ … \\ … \\ … \\ Byte n \text{:} Feed n \text{-} Master Volumn \\ Byte n + 1 \text{:} Feed n \text{-} Muted \\ Byte n + 2 \text{:} Feed n \text{-} Volumn \\ Byte n + 3 \text{:} Feed n \text{-} Audio Length Byte 1 \\ Byte n + 4 \text{:} Feed n \text{-} Audio Length Byte 2 \\ Byte n + 5 \text{-} Byte ( Audio Length From n + 3 and n + 4 ) \text{:} \\ Feed n \text{-} Audio Data\end{matrix}$$

The participating talent applications 166 then receive this data and adjusts the volume for its feed using the adjust_volume_u16 function defined above. It also displays the volume level that it gets from the get_volume_level. If not muted, the talent application 166 sends this adjusted audio data to the headset or other default audio device connected to the computer it is running on (i.e. first talent wireless in-ear speaker 114, second talent wireless in-ear speaker 116, N talent wireless in-ear speaker 118, P talent wireless in-ear speaker or wired speaker 120).

FIG. 2 illustrates general architecture for computing platforms usable for both the talent computing device and director computing device on which embodiments of a modern interruptible foldback may be implemented according to various aspects of present disclosure. Computer system 150 for example, may be used to execute at least some of the operations previously described. Computer system 150 may be embodied in the form of a: smart phone 150A, a tablet/PDA 150B, a server 150C, a desktop computer 150D, a laptop computer 150E, and a programmable custom electronic device with software 150F. A server is a computer program and/or a machine that waits for requests from other machines or software (clients) and responds to them. A server typically processes data. The purpose of a server is to share data and/or hardware and/or software resources among clients. This architecture is called the client-server model. The clients may run on the same computer or may connect to the server over a network. Examples of computing servers include database servers, file servers, mail servers, print servers, web servers, game servers, and application servers. The term server may be construed broadly to include any computerized process that shares a resource to one or more client processes. The computer system 150 may include at least one processor 152, memory 154, one or more storage device 156, and input/output (I/O) devices 157 such as used for user interface 158. Some or all of the computer components (152, 154, 156, 158) may be interconnected via a system bus 160. The processor 152 may be single or multi-threaded and may have one or more cores. The processor 152 may execute instructions, such as those stored in the memory 154 and/or in the storage device 156. Information may be received and output using one or more I/O devices 157.

The memory 154 may store information, and may be a computer-readable medium, such as volatile or non-volatile memory. The storage device(s) 156 may provide storage for the computer system 150, and may be a computer-readable medium. In various aspects, the storage device(s) 156 may be a flash memory device, a hard disk device, an optical disk device, a tape device, or any other type of storage device.

The I/O devices 157 may provide input/output operations for the computer system 150. I/O devices for user interface 158 may include one or more of: a display/touch screen, keyboard, a pointing device (mouse), button pad, slider, knobs, and a microphone. The features of the present embodiments described herein may be implemented in digital electronic circuitry, and/or in computer hardware, firmware, software, and/or in combinations thereof. Features of the present embodiments may be implemented in a computer program product tangibly embodied in an information carrier, such as a machine-readable storage device, and/or in a propagated signal, for execution by a programmable processor. Embodiments of the present method steps may be performed by a programmable processor executing a program of instructions to perform functions of the described implementations by operating on input data and generating output.

The features of the present embodiments described herein may be implemented in one or more computer programs (i.e. talent application 166, director application 164) that are executable on a programmable system including at least one programmable processor coupled to receive data and/or instructions from, and to transmit data and/or instructions to, a data storage system, at least one input device, and at least one output device. A computer program may include a set of instructions that may be used, directly or indirectly, in a computer to perform a certain activity or bring about a certain result. A computer program may be written in any form of programming language, including compiled or interpreted languages, and it may be deployed in any form, including as a stand-alone program or as a module, component, subroutine, or other unit suitable for use in a computing environment. Suitable processors for the execution of a program of instructions may include, for example, both general and special purpose processors, and/or the sole processor or one of multiple processors of any kind of computer. Generally, a processor may receive instructions and/or data from a read only memory (ROM), or a random access memory (RAM), or both. Such a computer may include a processor for executing instructions and one or more memories for storing instructions and/or data.

Generally, a computer may also include, or be operatively coupled to communicate with, one or more mass storage devices for storing data files. Such devices include magnetic disks, such as internal hard disks and/or removable disks, magneto-optical disks, and/or optical disks. Storage devices suitable for tangibly embodying computer program instructions and/or data may include all forms of non-volatile memory, including for example semiconductor memory devices, such as EPROM, EEPROM, and flash memory devices, magnetic disks such as internal hard disks and removable disks, magneto-optical disks, and CD-ROM and DVD-ROM disks. The processor and the memory may be supplemented by, or incorporated in, one or more ASICs (application-specific integrated circuits).

As presented earlier, to provide for interaction with a user, the features of the present embodiments may be implemented on a computer having a display device, such as an LCD (liquid crystal display) monitor, for displaying information to the user. The computer may further include a keyboard, a pointing device, such as a mouse or a trackball, and/or a touchscreen by which the user may provide input to the computer.

The features of the present embodiments may be implemented in a computer system that includes a back-end component, such as a data server, and/or that includes a middleware component, such as an application server or an Internet server, and/or that includes a front-end component, such as a client computer having a graphical user interface (GUI) and/or an Internet browser, or any combination of these. The components of the system may be connected by any form or medium of digital data communication, such as a communication network. Examples of communication networks may include, for example, a LAN (local area network), a WAN (wide area network), and/or the computers and networks forming the Internet.

The computer system may include clients and servers. A client and server may be remote from each other and interact through a network, such as those described herein. The relationship of client and server may arise by virtue of computer programs running on the respective computers and having a client-server relationship to each other.

The memory 154 may include both operating memory, such as random access memory (RAM), as well as data storage, such as read-only memory (ROM), hard drives, flash memory, or any other suitable memory/storage element. The memory 154 may include removable memory elements, such as a CompactFlash card, a MultiMediaCard (MMC), and/or a Secure Digital (SD) card. In some embodiments, the memory 154 may comprise a combination of magnetic, optical, and/or semiconductor memory, and may include, for example, RAM, ROM, flash drive, and/or a hard disk or drive. The processor 152 and the memory 154 each may be, for example, located entirely within a single device, or may be connected to each other by a communication medium, such as a USB port, a serial port cable, a coaxial cable, an Ethernet-type cable, a telephone line, a radio frequency transceiver, or other similar wireless or wired medium or combination of the foregoing. For example, the processor 152 may be connected to the memory 154 via a dataport.

The user interface 158 may include any user interface or presentation elements suitable for a computing device, such as a keypad, a display screen, a touchscreen, a microphone, and a speaker. The data transfer network 112 is configured to handle communication links between the client device and other, external devices or receivers, and to route incoming/outgoing data appropriately. The data transfer network 112 may include one or more transceiver modules capable of transmitting and receiving data, and using, for example, one or more protocols and/or technologies, such as GSM, UMTS (3GSM), IS-95 (CDMA one), IS-2000 (CDMA 2000), LTE, FDMA, TDMA, W-CDMA, CDMA, OFDMA, Wi-Fi, WiMAX, or any other protocol and/or technology.

Various types of ports (i.e. USB) are used to physically couple the computing devices to external hardware. The memory 154 may store instructions for communicating with other systems, such as a computer. The memory 154 may store, for example, a program (e.g., computer program code) adapted to direct the processor 152 in accordance with the present embodiments. The instructions also may include program elements, such as an operating system. While execution of sequences of instructions in the program causes the processor 152 to perform the process steps described herein, hard-wired circuitry may be used in place of, or in combination with, software/firmware instructions for implementation of the processes of the present embodiments. Thus, the present embodiments are not limited to any specific combination of hardware and software.

It is noted that the terms “substantially” and “about” and “generally” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

The foregoing invention has been described in accordance with the relevant legal standards, thus the description is exemplary rather than limiting in nature. Variations and modifications to the disclosed embodiment may become apparent to those skilled in the art and fall within the scope of the invention.

1. (canceled)

2. (canceled)

3. A modern interruptible foldback system comprising:
a director microphone;
a director microphone audio signal produced by said director microphone;
at least one audio stream;
an audio interface operable to produce digitized audio from said director microphone audio signal and said at least one audio stream;
a director computing device operable to receive said digitized audio;
said director computing device having a display;
a director application on said director computing device operable to configure said digitized audio on a processor of said director computing device;
a data transfer network operable to receive configured said digitized data from said director computing device;
one or more talent computing devices;
said one or more talent computing devices having a display;
a talent application on said one or more talent computing devices operable to receive configured said digitized audio from said data transfer network;
an in-ear speaker matched with each said one or more talent computing devices operable to produce sound consequent to the said digitized audio received over said data transfer network.

4. The modern interruptible foldback system of claim 3 whereas said director microphone audio signal and said at least one audio stream is configured in said director app of said director computing device.

5. The modern interruptible foldback system of claim 3 further comprising:
one or more analog audio mixer;
whereas said director microphone audio signal and said at least one audio stream are mixed in said one or more analog audio mixer prior to being received in said audio interface.

6. The modern interruptible foldback system of claim 3 whereas said director microphone audio signal and said at least one audio stream are mixed in one of said director computing device and talent computing device prior to being received by said audio interface.

7. The modern interruptible foldback system of claim 3 whereas said director microphone audio signal and said at least one audio stream are amplified before mixing.

8. The modern interruptible foldback system of claim 3 whereas said in-ear speaker utilizes a wireless connection to receive said digitized audio from respective said talent computing device.

9. The modern interruptible foldback system of claim 3 whereas said in-ear speaker utilizes a wired connection to receive said digitized audio from respective said talent computing device.

10. The modern interruptible foldback system of claim 3 whereas said data transfer network utilizes a wireless data transfer protocol to transfer configured said digitized audio to said one or more talent computing devices.

11. The modern interruptible foldback system of claim 3 further comprising:
a signal button depicted on said talent display by said talent application;
a call light depicted on said director display by said director application;
whereas activation of said signal button as a graphic interface option results in consequent activation of said call light on said director display.

12. The modern interruptible foldback system of claim 3 further comprising:
a volume control displayed as a graphic interface option on said director display to adjust the volume for each talent.

13. The modern interruptible foldback system of claim 3 further comprising:
a talk control displayed as a graphic interface option on said director display operable to activate transmission of audio signals from said director microphone to a predetermined talent in-ear speaker.

14. The modern interruptible foldback system of claim 3 further comprising:
a connection indicator displayed as a graphic interface option on said director display indicative of the connection status of a designated talent computing device to the system.

15. The modern interruptible foldback system of claim 3 further comprising:
a stream control displayed as a graphic interface option on said director display operable to activate and inactivate one or more streams of said digitized audio to a designated talent.

16. The modern interruptible foldback system of claim 3 further comprising:
a network control displayed as a graphic interface option on said director display operable to control network settings and connection ports.

17. The modern interruptible foldback system of claim 3 further comprising:
an audio input settings displayed as a graphic interface option on said director display operable to select a specified audio input source.

18. The modern interruptible foldback system of claim 3 further comprising:
a quick connect toggle displayed as a graphic interface option on said talent display that provides rapid connection of said talent computing device to said data transfer network.

19. A method of distributing audio streams to talent comprising the steps of:
a director computing device accessing a network port;
one or more talent computing devices networking with the director computing device;
configuring audio data utilizing a director application on the director computing device;
receiving incoming audio streams into said director computing device;
sending a data packet of audio having a unique configuration over a network to each connected talent computing device;
receiving the configuration data in the talent computing device;
parsing the configuration data packet and setting up audio channels on each talent computing device accordingly;
mixing the digitized audio according to the configured audio channel specification;
routing the mixed audio to the sound controller;
opening a wireless communication link between the talent computer and respective wireless earphone;
converting the digital signal to analog and amplifying in a wireless earphone.

20. The method of claim 19 further comprising the step of overriding preselected configuration settings by graphic interface options on said talent display.

21. The method of claim 19 further comprising the step of amplifying and mixing said director mic audio signal and said audio streams prior to the step of receiving incoming audio streams into said director computing device.

22. The method of claim 19 further comprising the steps of:
activating a user interface button to signal an intended message for display on the director computing display;
configuring the message data in a packet;
sending the data packet via the network to the director computing device;
displaying the intended message on the director computing display.
